(19) United States
(12) Patent Application Publication
(10) Pub. No.: US 2026/0311894 A1
(43) Pub. Date: Oct. 8, 2026

(54) DIVERTOR GAS PUFFING

(71) Applicant: Tokamak Energy Ltd, Milton, Abingdon, Oxfordshire (GB)

(72) Inventors: Mike Jackson, Milton, Abingdon (GB); Vivian Lee, Milton, Abingdon (GB)

(21) Appl. No.: 19/483,531

(22) PCT Filed: May 8, 2024
(86) PCT No.: PCT/EP2024/062839

§ 371 Date: Nov. 11, 2025

(30) Foreign Application Priority Data
May 11, 2023 (GB) 2306948.7

(51) Int. Cl. G21B 1/13; F16K 31/00; G21B 1/05

(52) U.S. Cl. CPC G21B 1/13; F16K 31/002; G21B 1/057

(57) ABSTRACT

A divertor assembly for use in a magnetic confinement plasma chamber. The divertor assembly includes a divertor plate, a gas source, and a system. The divertor plate has an external plasma facing surface and one or more conduits extending through the divertor plate to open at the external plasma facing surface. The gas source is configured to provide a gas to the conduits. The system is configured to control the flow of gas from the gas source to the external plasma facing surface.

### FIELD OF THE INVENTION

The present invention relates to gas puffing in a tokamak.

### BACKGROUND

A tokamak is a device that uses a magnetic field to confine the plasma within a plasma vessel. Tokamaks have a divertor, which acts as a heat dump or exhaust channel for “hot” plasma that is not contained by the magnetic field. For this reason, the divertor is subject to very large heat fluxes.

FIG. 1 shows a poloidal cross section of an exemplary tokamak. The tokamak 100 comprises a toroidal plasma chamber 101. Poloidal magnetic field coils (not shown) produce a poloidal magnetic field, which confines the plasma. The magnetic field lines effectively form toroidally symmetric, nested surfaces to which the plasma (i.e., a “soup” of charged particles) is constrained. These nested surfaces are represented as lines of constant poloidal flux 113 in FIG. 1. Inside these nested surfaces, the plasma is said to be confined inside the “plasma core”. However, via collisions and other such processes, the plasma slowly diffuses out from the plasma core, towards the plasma chamber walls. To reduce interaction with the plasma chamber walls, a poloidal field null 112 (the “X” point) is generated using dedicated shaping coils. The region of the plasma inside the field line which passes through the null is called the “plasma envelope” or “plasma core”, and the region outside the field line is called the “scrape-off layer”. The null point 112 causes some flux lines (e.g., flux line 114) to intersect two surfaces below the null point 112: the outboard (i.e., a radially outer) divertor surface 121 and the inboard (i.e., radially inner) divertor surface 122. The flux line that defines the null point 112 (i.e., the flux line that passes through the null) also intersects the outboard and inboard divertor surfaces 121, 122. The location of these intersections is referred to as the “strike point”, as the plasma which diffuses from the plasma core will follow the flux lines and will be concentrated around the strike points when it strikes the divertor. At the strike point, the heat flux is at a maximum.

One measure which is used to mitigate the wear on the divertor is the use of a neutral “gas puff” introduced into the scrape off layer. The gas puff interacts with the plasma in the scrape off layer, cooling it down so that by the time it reaches the divertor, much of the plasma has recombined into a neutral gas—a process called “detachment”. This both reduces the energy of the particles striking the divertor surface, and spreads them out over a wider area around the strike point (as the neutral particles are not confined by the field lines). Full detachment is achieved when the plasma is substantially neutralised over the whole divertor surface, and partial detachment is achieved when the plasma is substantially neutralised over at least a part of the divertor surface—both are viable approaches in practical applications, and “detachment” herein may refer to either state. One issue with this gas puffing approach is that it can introduce impurities into the plasma itself—as either the neutral particles from the gas puff, or neutralised waste products in the plasma from the scrape-off layer, can enter the plasma envelope. This will tend to cool down the plasma and potentially introduce further instabilities. Note that this is distinct from the use of gas puffing in some tokamaks to deliberately introduce more material into the plasma—where gas puffing is used to provide detachment for the divertor surfaces, the introduction of material into the plasma envelope is often unwanted.

### SUMMARY

According to a first aspect, there is provided a divertor assembly for use in a magnetic confinement plasma chamber. The divertor assembly comprises a divertor plate, a gas source, and a system. The divertor plate has an external plasma facing surface and one or more conduits extending through the divertor plate to open at the external plasma facing surface. The gas source is configured to provide a gas to the conduits. The system is configured to control the flow of gas from the gas source to the external plasma facing surface.

Further embodiments are provided in claims 2 et seq.

According to a second aspect, there is provided a method of operating a divertor assembly in a magnetic confinement plasma chamber. The divertor assembly comprises a divertor plate having an external plasma facing surface and one or more conduits extending through the divertor plate to open at the external plasma facing surface. The method comprises providing a gas into the plasma chamber at the external plasma facing surface via the plurality of conduits.

The method of the second aspect may be performed to operate a divertor assembly of the first aspect or its embodiments.

According to a third aspect, there is provided a method of cooling a surface of an object. The object comprises a plurality of conduits extending through the object to the surface. The method comprises providing a gas to the surface through the conduits at a pressure greater than an ambient pressure at the surface.

### BRIEF DESCRIPTION OF THE DRAWINGS

FIG. 1 shows a poloidal cross section of an exemplary tokamak;

FIG. 2 shows a divertor target having integrated conduits for gas puffing;

FIGS. 3A and 3B show exemplary passive temperature controlled valves; and

FIG. 4 shows an object having integrated conduits for cooling.

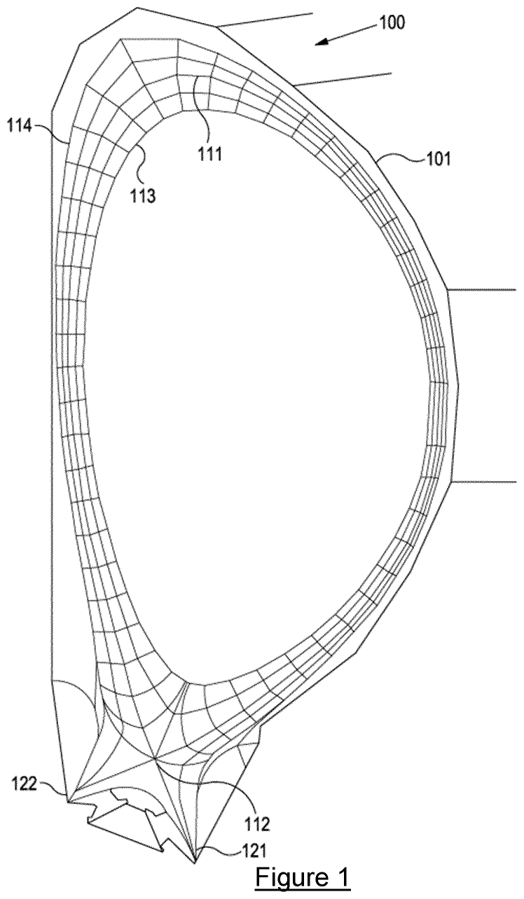

### DETAILED DESCRIPTION

One way to mitigate the issue of the introduction of material to the plasma from gas puffing and subsequent detachment is to perform the gas puffing in the region of the divertor, rather than in regions of the scrape-off layer closer to the plasma envelope (e.g. in the mid-plane). This is a trade-off between the risk of contamination and the effectiveness of the gas puff in producing detachment, as the plasma will interact with the gas over a shorter distance, but can still provide enough cooling to the plasma approaching the divertor to cause detachment (full or partial).

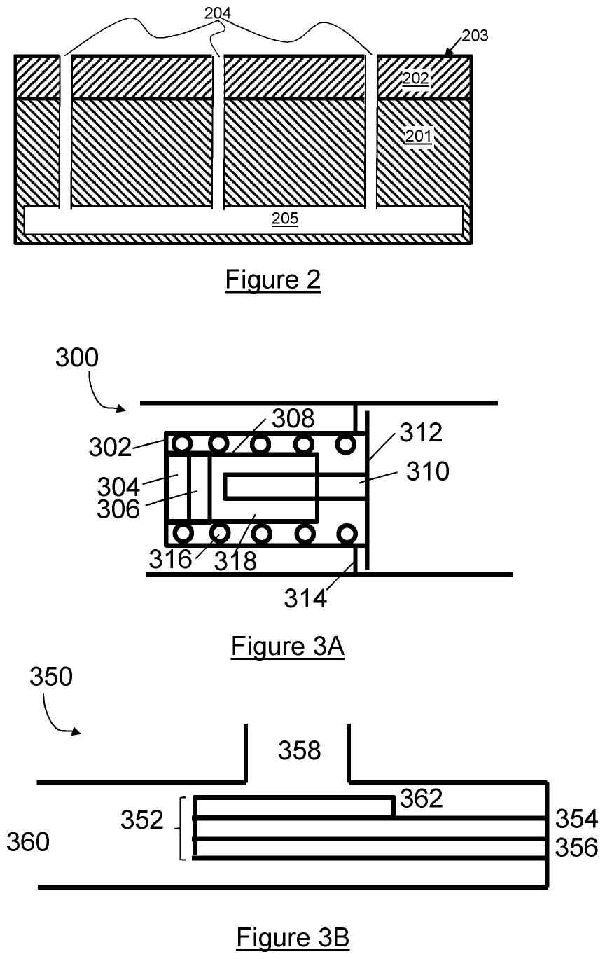

FIG. 2 shows a divertor target having integrated conduits for gas puffing. The divertor target is formed from a heatsink 201 and an armour layer 202, with the armour layer extending to an external plasma facing surface 203 (i.e. the surface which will be contacted by the incoming material from the plasma). The heat sink may be formed from, for example, copper, and the armour may be formed from, for example, a refractory metal such as tungsten. The divertor target comprises several conduits 204 which each extend to and are open at the external plasma facing surface 203, and which connect to a gas source 205. Examples of the gas source are described in more detail below, but it may be a reservoir or a gas pumping system, and may be internal to the divertor target as shown here or external to the divertor target and connected to the conduits 204 by suitable means.

In order to provide a gas puff to achieve detachment at the divertor surface, gas from the gas source 205 is allowed to flow out into the plasma chamber at the external facing plasma surface 203 via the conduits 204. This ensures that the gas puff is provided as close as possible to the external plasma facing surface (i.e. at the surface), and so minimises the risk of material from the gas puff entering the plasma envelope.

Typically, the gas puff will be sufficient to achieve a density of 10¹⁹ electrons per cubic meter within the region of the divertor, which corresponds to a gas puff of around 10²³ atoms per second for a deuterium gas puff. These figures are given by way of example only—depending on the size of the reactor, the thermal tolerances of the divertor, and the expected energy of the incoming particles, more or less gas may be used. Various gasses may be used, e.g. neon, argon, nitrogen, or deuterium.

Gas from the puff can be removed from the plasma chamber by existing vacuum systems as will be present in the chamber.

Additionally, the gas will have a cooling effect as it travels through the divertor target, and will have a further cooling effect at the external plasma facing surface due to the expansion of the gas into the extremely low pressure of the plasma chamber. The cooling effect as the gas travels through the conduits may be enhanced as usual for coolant conduits—e.g. by providing a longer length, or by providing cooling fins within the conduit. The cooling effect at the external plasma facing surface may be enhanced by causing the gas to leave the conduits at a higher pressure.

Control of the gas puff may be by various means. Such control may be periodic (i.e. providing a gas puff on a set timescale), active (e.g. a controller causing the system to provide a gas puff based on a software determination based on measurements of the state of the plasma chamber and/or divertor), or passive (e.g. providing means which cause a gas puff to happen based on the state of the plasma chamber and/or divertor, without the need for software or manual control).

Passively controlled means may be used to control the gas puff. Here, “passive” refers to control mechanisms which do not rely on human or software logic to cause a gas puff to occur in response to changes of state in the plasma chamber and/or the divertor target. One example of a passive control system for the conduits in the divertor target is a temperature-sensitive valve, i.e. a valve which restricts or allows the flow of gas based on the temperature at some location within the divertor target. As a gas puff is generally required to cool the divertor target and/or mitigate heating to the divertor target, such a valve would be configured to allow flow based on a temperature of the divertor plate (or a component in thermal contact with the divertor plate), i.e. preventing gas flow when the temperature is below a first predetermined temperature, allowing gas to pass when the temperature rises above a first predetermined temperature, and optionally increasing the flow of gas up to a second predetermined temperature at which maximum flow is reached.

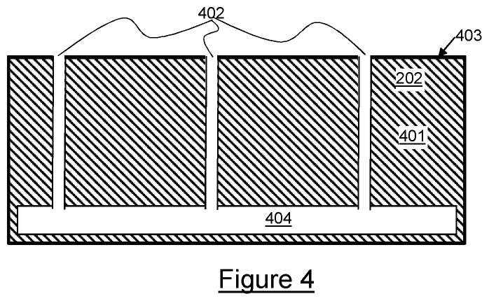

FIGS. 3A and 3B show schematic illustrations of exemplary passive valves for the divertor assembly.

In FIG. 3A, the passive valve 300 comprises an expandable-element thermostat, which is well-known to the skilled reader. The passive valve comprises: a valve housing 302; one or more expandable elements 304, 306 (e.g., a wax element) sealed using sealant 318 within a column 308 located in the valve housing 302; a rod or pin 310, wherein one end of the rod or pin 310 is mechanically coupled to the column 308 and the other end of the rod or pin 310 comprises a cap 312; a valve seat 314; and a biasing element 316 (e.g., a spring) configured to urge cap 312 against the valve seat 314.

The expandable elements 304, 306 are configured such that, at temperatures below the first predetermined temperature, the biasing element 316 (e.g., spring) is sufficiently stiff enough to essentially maintain a seal between cap 312 and the valve seat 314. The seal may not necessarily be “fluid-tight”, but, preferably, the seal should significantly restrict flow through the valve. That is, below the first predetermined temperature, the passive valve 300 is essentially closed and gas cannot pass around the passive valve 300 or, at the very least, flow of gas through the passive valve 300 is significantly restricted.

On the other hand, the biasing element 316 (e.g., spring) is sufficiently compliant such that, when the expandable elements 304, 306 heat up above the first predetermined temperature and expand, they 304, 306 are able to urge the cap 312 (via the rod 310) away from the valve seat 314. This causes the valve seat 314 and cap 312 to separate (to a greater extent), thereby defining a lower resistance path for gas to flow around the passive valve 300.

In some examples, the one or more expandable elements 304, 306 are solid and are configured to undergo a phase transition (i.e. melt) during heating. The melting temperature may correspond to the second predetermined temperature because melting leads to significant expansion.

In some examples, the one or more expandable elements 304, 306 have different melting points and therefore melt at different temperatures. In such cases, the one or more expandable elements 304, 306 may be arranged in series with one another in the column 308, such that melting of each of the expandable elements 304, 306 with different melting point leads to a corresponding step change in the separation between cap 312 and valve seat 314. In these examples, the second predetermined temperature corresponds to the highest melting point of the one or more expandable elements 304, 306.

When the expandable elements 304, 306 are solid, the change in separation between valve seat 314 and cap 312 is proportional to the change in temperature. Such a passive valve would be suitable for controlling the flow rate of gas into the conduits of the divertor plate. However, the change in separation between the valve seat 314, and cap 312 would be relatively small compared to a valve that uses expandable elements which melt. Nevertheless, mechanical levers can be used to magnify this relatively small displacement, if required.

When the expandable elements 304, 306 have melting points between the first and second predetermined temperature (e.g., at the second predetermined temperature), then the resistance of the valve 300 to flow may drastically reduce at these melting points. The “second predetermined temperature” can therefore be set according to the melting point of the expandable elements 304, 306.

In FIG. 3B, the passive valve 350 comprises a structure 352 of at least two materials 354, 356 with differing thermal expansion coefficients. The passive valve is arranged within the conduits 204. An example of the structure is a bimetallic strip, which is well-known to the skilled reader. As the structure is heated, the differential between the thermal expansion of the different materials leads to bending. For example, in FIG. 3B, if material 354 exhibits a higher thermal expansion than material 356, then the structure 352 bends away from the outlet 358 to open the valve as the temperature increases. This actuation can be used to close and/or open the valve 350. Optionally, a seal 362 is disposed on the structure 352 configured to form a fluid tight seal with outlet 358.

The use of such valves may be combined with a passive gas source, i.e. one not requiring active control to provide gas, such as a reservoir, with the flow of gas from the reservoir to the divertor surface being controlled primarily by the passive valves. Further active (i.e. externally controlled) valves may be provided to restrict the gas flow e.g. when the plasma chamber is not operating, but these may be left open during operation of the plasma chamber to allow the gas puffs to be controlled passively during operation.

As an alternative or in addition to the passive control means, the gas puff may be controlled by valves (e.g. active valves in addition to the passive valves described above) or other controllable restriction in the conduits within the divertor target, or in conduits connecting the divertor target to the gas source. Alternatively or additionally, the gas puff may be controlled by a pump or other means at the gas source to controllably provide gas to the conduits.

The operation of the gas puff may be controlled by a controller, i.e. a processor running software (or equivalent hardware circuit) which is configured to control the active valves, pumps, or other control means provided to control the flow of gas through the conduits 204. The controller may be integrated with the tokamak plasma chamber, or may be remote, and may be a controller specific to the gas puff system and/or the divertor assembly as a whole, or may be a controller which controls the gas puff as well as other aspects of the tokamak plasma chamber. While a controller is presented herein as one hardware option, it will be appreciated that the methods disclosed herein may be performed without a controlling entity such as a controller.

The controller may be configured to operate the gas puff on a pre-set timing, e.g. periodically or with a set timing based on expected requirements of the tokamak plasma chamber. Alternatively, the controller may be provided with programming to determine whether to provide a gas puff based on the state of the plasma chamber as measured by sensors or provided by other systems or other inputs, such as:
Inputs to other control devices of the plasma chamber;
State of the plasma within the chamber, e.g. plasma temperature, plasma current, or other properties;
State of the divertor targets, e.g. temperature, wear, stress, detection of charged particles impacting the targets, or other properties;
Other state of the plasma chamber, e.g. density of gas in the region of the divertor targets
Instructions from other controllers of the tokamak plasma chamber;
Human input.

Operating the gas puff may comprise opening active valves in the conduits within the divertor target or connecting the divertor target to the gas supply, and/or operating the gas supply to provide gas to the conduits.

As noted above, in addition to the use for achieving detachment for a divertor in a tokamak, providing a gas to the surface of an object through conduits within that object will also cause cooling by expansion of the gas (if the gas is provided at a higher pressure than the ambient pressure at the surface). Such cooling may be used for any surface which is reasonably open—i.e. has sufficient volume external to the surface to allow the gas to expand and achieve the cooling effect. As the cooling will depend on the pressure difference between the cooling gas and the ambient pressure, this is particularly useful in low pressure environments, e.g. in jet engines operating at high altitudes.

An example is shown in FIG. 4, where an object 401 has within it a plurality of conduits 402 extending through the object to a surface 403. By providing gas to the surface through the conduits, at a pressure greater than an ambient pressure at the surface, the surface of the object is cooled by the expansion of the gas. The gas may be supplied from a gas source 404 as described previously with respect to the divertor gas puff, which may be either internal or external to the object, and systems to control the flow of gas may be used as with the divertor gas puff, e.g. valves which open dependent on a temperature of the object.

Such cooling may be used within a tokamak, e.g. for the first wall, i.e. where the object of FIG. 4 is a part of the first wall and the surface is a plasma facing surface.

1. A divertor assembly for use in a magnetic confinement plasma chamber, the divertor assembly comprising:
a divertor plate having an external plasma facing surface and one or more conduits extending through the divertor plate to open at the external plasma facing surface;
a gas source configured to provide a gas to the conduits; and
a system configured to control a flow of gas from the gas source to the external plasma facing surface, the system comprising one or more valves within the one or more conduits, the one or more valves being configured to restrict the flow of gas to the external plasma facing surface;
wherein the one or more valves are passive temperature controlled valves configured to allow passage of gas to the external plasma facing surface in response to a temperature being above a threshold.

2. The divertor assembly according to claim 1, wherein each valve is configured to:
open as the temperature increases from a first predetermined temperature to a second predetermined temperature to monotonically decrease a flow resistance of the valve; and
close as the temperature decreases from the second predetermined temperature to the first predetermined temperature to monotonically increase the flow resistance of the valve.

3. The divertor assembly according to claim 2, wherein each valve comprises one or more stacked expandable elements, having a melting point substantially equal to the second predetermined temperature, such that, when said expandable elements melt, a cap, attached to one end of a rod which is mechanically coupled to said expandable elements, is urged away from a valve seat to open the valve.

4. The divertor assembly according to claim 3, wherein each valve comprises a structure comprising at least two materials with differing thermal expansion coefficients, wherein the structure is arranged to obstruct flow through the valve to a greater degree at lower temperatures.

5. The divertor assembly according to claim 1, wherein the system configured to control the flow of gas comprises a controller and one or more further valves or controllable restrictions in the conduits, and the controller is configured to cause the one or more further valves or controllable restrictions to allow flow of gas from the gas source to the external plasma facing surface based on measurements of one or more of:
temperature of the external plasma facing surface;
properties of a plasma within the magnetic confinement plasma chamber; and
quantity of gas within the magnetic confinement plasma chamber.

6. The divertor assembly according to claim 1, wherein the gas source is a reservoir.

7. The divertor assembly according to claim 1, wherein the gas source comprises a pump.

8. A method of operating a divertor assembly in a magnetic confinement plasma chamber, the divertor assembly comprising a divertor plate having an external plasma facing surface and one or more conduits extending through the divertor plate to open at the external plasma facing surface, the method comprising providing a gas into the magnetic confinement plasma chamber at the external plasma facing surface via a plurality of conduits, a flow of gas via the plurality of conduits being controlled by one or more valves, wherein the one or more valves are temperature controlled valves configured to allow passage of gas to the external plasma facing surface in response to temperature above a threshold.

9. The method according to claim 8, wherein the divertor assembly comprises a gas source configured to provide a gas to the conduits and a system configured to control the flow of gas from the gas source to the external plasma facing surface, the system comprising the one or more valves, and wherein providing the gas into the magnetic confinement plasma chamber at the external plasma facing surface via the plurality of conduits comprises the system permitting the flow of gas from the gas source into the magnetic confinement plasma chamber.

10. A method of cooling a surface of an object, wherein the object comprises a plurality of conduits extending through the object to the surface, the method comprising providing a gas to the surface through the conduits at a pressure greater than an ambient pressure at the surface, a flow of gas via the conduits being controlled by one or more valves, wherein the one or more valves are temperature controlled valves configured to allow passage of gas to an external plasma facing surface in response to temperature above a threshold.
